(19) United States
(12) Patent Application Publication
(10) Pub. No.: US 2015/0212377 A1
(43) Pub. Date: Jul. 30, 2015

(54) LIQUID CRYSTAL DISPLAY PANEL AND LIQUID CRYSTAL DISPLAY DEVICE

(71) Applicant: Sharp Kabushiki Kaisha, Osaka-shi, Osaka (JP)

(72) Inventors: Takao Imaoku, Osaka-shi (JP); Yuichi Iyama, Osaka-shi (JP); Iori Aoyama, Osaka-shi (JP); Takatomo Yoshioka, Osaka-shi (JP); Kazuhiko Tsuda, Osaka-shi (JP); Mitsuhiro Murata, Osaka-shi (JP)

(73) Assignee: SHARP KABUSHIKI KAISHA, Osaka-shi, Osaka (JP)

(21) Appl. No.: 14/126,461

(22) PCT Filed: May 31, 2012
(86) PCT No.: PCT/JP12/64228

§ 371 Date: Dec. 16, 2013

(30) Foreign Application Priority Data
Jun. 27, 2011 (JP) 2011-142348

(51) Int. Cl. G02F 1/1343; G02F 1/137; G02F 1/1368

(52) U.S. Cl. CPC G02F 1/134363; G02F 1/1368; G02F 1/137; G02F 2001/13706

(57) ABSTRACT

The present invention provides a liquid crystal display panel and a liquid crystal display device each of which exhibits a sufficiently increased transmittance and an excellent response speed in falling, with its three-layered electrode structure that controls the alignment of liquid crystal molecules by an electric field in both rising and falling. The liquid crystal display panel of the present invention includes: a first substrate; a second substrate; and a liquid crystal layer disposed between the substrates, the first substrate and the second substrate each having an electrode, the first substrate further having a dielectric layer, the electrode of the second substrate including a pair of comb-shaped electrodes and a planar electrode.

### TECHNICAL FIELD

The present invention relates to a liquid crystal display panel and a liquid crystal display device. More specifically, the present invention relates to a liquid crystal display panel and a liquid crystal display device each of which has a three-layered electrode structure that controls the alignment of liquid crystal molecules by an electric field in both rising and falling.

### BACKGROUND ART

A liquid crystal display panel includes a pair of substrates such as glass substrates and a liquid crystal layer disposed therebetween. Such a liquid crystal display panel characteristically has a thin profile, a light weight, and a low power consumption, and is indispensable in everyday life and business as a display for devices including personal computers, televisions, onboard devices (e.g. automotive navigation systems), and personal digital assistants (e.g. mobile phones). In these applications, persons skilled in the art have studied liquid crystal display panels of various modes in which the placement of electrodes and the design of the substrates are different for changing the optical characteristics of the liquid crystal layer.

Examples of the display modes of current liquid crystal display devices include: a vertical alignment (VA) mode in which liquid crystal molecules having negative anisotropy of dielectric constant are aligned vertically to the substrate surfaces; an in-plane switching (IPS) mode in which liquid crystal molecules having positive or negative anisotropy of dielectric constant are aligned horizontally to the substrate surfaces and a transverse electric field is applied to the liquid crystal layer; and a fringe field switching (FFS) mode.

One document discloses, as a FFS-driving liquid crystal display device, a thin-film-transistor liquid crystal display having a high response speed and a wide viewing angle. The device includes a first substrate having a first common electrode layer; a second substrate having a pixel electrode layer and a second common electrode layer; a liquid crystal disposed between the first substrate and the second substrate; and a means for generating an electric field between the first common electrode layer of the first substrate and both of the pixel electrode layer and the second common electrode layer of the second substrate so as to provide high speed response to a fast input-data-transfer rate and a wide viewing angle for a viewer (for example, see Patent Literature 1).

Another document discloses, as a liquid crystal device with multiple electrodes applying a transverse electric field, a liquid crystal device including a pair of substrates opposite to each other; a liquid crystal layer which includes a liquid crystal having a positive anisotropy of dielectric constant and which is disposed between the substrates; electrodes which are provided to the respective first substrate and second substrate constituting the pair of substrates, facing each other with the liquid crystal layer therebetween, and which apply a vertical electric field to the liquid crystal layer; and multiple electrodes for applying a transverse electric field to the liquid crystal layer disposed on the second substrate (for example, see Patent Literature 2).

### CITATION LIST

### Patent Literature

Patent Literature 1: JP 2006-523850 T

Patent Literature 2: JP 2002-365657 A

### SUMMARY OF INVENTION

### Technical Problem

Patent Literature 1 teaches a vertical alignment liquid crystal display device having a three-layered electrode structure which achieves high-speed response by rotating the liquid crystal molecules by an electric field in both rising and falling. The rising utilizes a fringe electric field (FFS driving) generated between an upper slit electrode and a lower solid electrode of the lower substrate. The falling utilizes a vertical electric field generated by a potential difference between the substrates.

FIG. 19 is a schematic plan view showing a subpixel in a liquid crystal display panel having an FFS structure. FIG. 20 is a schematic cross-sectional view of a liquid crystal display panel having a conventional FFS-driving electrode structure in which the lower substrate has a conventional FFS structure. FIG. 21 shows simulation results of director d distribution, electric field distribution, and transmittance distribution (solid line) in rising. FIG. 20 shows the structure of the liquid crystal display panel where a certain voltage is applied to a slit electrode 217 (14 V in the figure). A substrate with the slit electrode 217 and an opposed substrate are respectively provided with common electrodes 213 and 223. The common electrodes 213 and 223 are set to 7 V.

Even when a fringe electric field is applied to a vertical alignment liquid crystal display device, only the liquid crystal molecules near the slit electrode ends are rotated (cf. FIG. 21). Hence, the transmittance thereof may be insufficient. In view of this, the present inventors have used a pair of comb-shaped electrodes for comb driving in place of the upper slit electrode, so that the liquid crystal molecules between the comb-shaped electrodes are sufficiently aligned in the horizontal direction. The use has been found to increase the transmittance per unit area of an aperture.

The comb driving, however, usually requires three thin-film transistor elements (TFTs) per subpixel. An increase in the number of TFTs reduces the size of the apertures, so that the aperture ratio decreases. As a result, the transmittance may not be sufficiently increased.

The technique for increasing the transmittance may possibly be increasing the thickness of the liquid crystal cell to allow the effect of the transverse electric field become dominant or increasing the voltage to be applied between the comb-shaped electrodes (increasing the intensity of the transverse electric field). Increasing the thickness of the liquid crystal cell improves the effect of the transverse electric field, thereby increasing the transmittance. Meanwhile, the viewing angle characteristics (especially the viewing angle compensation of a polarizer) may be deteriorated. A problem from the cost aspect, such as an increase in the amount of liquid crystal molecules, is also raised. Similarly, increasing the voltage applied between the comb-shaped electrodes improves the effect of the transverse electric field, thereby increasing the transmittance. This technique, however, is not easily adopted because of the possibility of failing to maintain a sufficient TFT voltage proof and in terms of development of a driving driver for increasing the voltage applied to the comb-shaped electrodes.

The present invention has been made in view of the above state of the art, and aims to provide a liquid crystal display panel and a liquid crystal display device each of which exhibits a sufficiently increased transmittance and an excellent response speed in falling, with its three-layered electrode structure that controls the alignment of liquid crystal molecules by an electric field in both rising and falling.

### Solution to Problem

The present inventors have considered achieving both a high response speed and a high transmittance in a liquid crystal display panel and a liquid crystal display device, and have focused on a liquid crystal display panel with a three-layered electrode structure which controls the alignment of liquid crystal molecules by an electric field in both rising and falling. The present inventors have found that, when a first substrate and a second substrate having a liquid crystal layer disposed therebetween each have an electrode and the electrode of the second substrate includes a pair of comb-shaped electrodes and a planar electrode, a transverse electric field can be generated by the potential difference between the pair of comb-shaped electrodes in rising, and a vertical electric field can be generated by the potential difference between the substrates in falling, for example. This three-layered electrode structure enables suitable switching between the vertical electric field ON state and the transverse electric field ON state. The three-layered electrode structure has been found to provide a high response speed by rotating liquid crystal molecules by an electric field in both rising and falling, as well as a high transmittance per unit area of an aperture by the transverse electric field generated in comb driving.

The present inventors have further made studies, and have focused on providing a dielectric layer to a first substrate (opposed substrate) in a liquid crystal display panel and a liquid crystal display device having the above structure. They have therefore found that providing a dielectric layer on the opposed substrate side further increases the intensity of the transverse electric field. The provision has also been found to further increase the transmittance. The present inventors have accordingly solved the above problems, completing the present invention.

The present invention is different from the prior art inventions in the following features. One of the features is that the vertical alignment liquid crystal display device of the present invention having a three-layered electrode structure achieves a high response speed by utilizing comb driving for the upper electrode of the lower substrate to generate a transverse electric field by a potential difference between the comb-shaped electrodes in rising and generate a vertical electric field by a potential difference between the substrates in falling, thereby rotating the liquid crystal molecules by an electric field in both rising and falling. Another feature is that such a display device also achieves a high transmittance in apertures by the transverse electric field generated by the comb driving. In addition, providing a dielectric layer on the opposed substrate side in the vertical alignment liquid crystal display device having a three-layered electrode structure further increases the transmittance. Here, the present invention increases the response speed having been problematic especially at low temperatures, and also achieves an excellent transmittance.

Patent Literature 1 teaches the effect of a dielectric, but does not teach any actual driving method. Patent Literature 1 merely teaches the effect of increasing the fringe field, without suggesting application of the effect to liquid crystal display panels having the electrode structure of the present invention. Here, simply providing a dielectric layer may deteriorate the OFF characteristics (response speed in falling; also referred to as a decay speed). The OFF characteristics refer typically to an increase in the response speed in falling and a sufficient decrease in the transmittance in black display. The OFF characteristics herein primarily refer to the response speed in falling, unless otherwise stated.

One aspect of the present invention is a liquid crystal display panel including: a first substrate; a second substrate; and a liquid crystal layer disposed between the substrates, the first substrate and the second substrate each having an electrode, the first substrate further having a dielectric layer, the electrode of the second substrate including a pair of comb-shaped electrodes and a planar electrode. The liquid crystal display panel of the present invention has a three-layered electrode structure that controls the alignment of liquid crystal molecules by an electric field in both rising and falling. To further increase the transmittance of such a liquid crystal display panel, a dielectric layer is disposed on the opposed substrate side. This structure increases the intensity of the transverse electric field on the opposed substrate side (upper portion of the liquid crystal layer), and therefore significantly raises the utilization efficiency of light to increase the transmittance.

Also, simply providing a dielectric layer may not easily allow sufficient application of a vertical electric field, decreasing the response speed (decay speed) in falling. To sufficiently increase the response speed in falling, the following features (1) to (3) can be adopted. (1) A feature with a great electric field between the upper and lower substrates. (2) A feature with a dielectric layer having an increased dielectric constant ε_{oc}. (3) A feature with a dielectric layer having a reduced thickness d_{oc}. Any one of the features (1) to (3) sufficiently increases the response speed in falling, but it is more preferred to combine the features (1) to (3).

Firstly, the feature (1) with a great electric field between the upper and lower substrates is described. For example, the liquid crystal display panel preferably has a potential difference of 1 V or more applied between the electrode of the first substrate and the electrodes of the second substrate. In this case, deterioration in the response characteristics in falling can be sufficiently suppressed. The upper limit of the potential difference between the electrode of the first substrate and the electrodes of the second substrate is preferably 15 V or less when voltages are applied to the electrodes.

The feature (2) with a dielectric layer having an increased dielectric constant ε_{oc} is described. For example, the dielectric constant ε_{oc} of the dielectric layer is preferably 2.5 or more. The upper limit of the dielectric constant ε_{oc} is preferably 9 or less. In terms of the transmittance, the dielectric constant ε_{oc} of the dielectric layer is preferably, for example, less than 3.8. The dielectric constant ε_{oc} is most preferably about 3.0.

The feature (3) with a dielectric layer having a reduced thickness d_{oc} is described. For example, the thickness d_{oc} of the dielectric layer is preferably 3.5 μm or less, and more preferably 2 μm or less. The lower limit of the thickness d_{oc} is preferably 1 μm or more.

The pair of comb-shaped electrodes may be disposed in any form as long as the two comb-shaped electrodes are disposed to face each other. The pair of comb-shaped electrodes is capable of suitably generating a transverse electric field therebetween. With the electrodes, the response characteristics and the transmittance in rising are excellent when the liquid crystal layer contains liquid crystal molecules having positive anisotropy of dielectric constant, while a high response speed is achieved by rotating the liquid crystal molecules by the transverse electric field in falling when the liquid crystal layer contains liquid crystal molecules having negative anisotropy of dielectric constant. The liquid crystal display panel is preferably configured to align liquid crystal molecules between the pair of comb-shaped electrodes in the liquid crystal layer in the horizontal direction to the main faces of the substrates by an electric field generated between the pair of comb-shaped electrodes or between the electrode of the first substrate and the electrodes of the second substrate. The electrodes of the first substrate and the second substrate may be any electrodes capable of providing a potential difference between the substrates. With such electrodes, a vertical electric field is generated by a potential difference between the substrates in falling with liquid crystal molecules having positive anisotropy of dielectric constant contained in the liquid crystal layer and in rising with liquid crystal molecules having negative anisotropy of dielectric constant contained in the liquid crystal layer. The generated electric field rotates the liquid crystal molecules, thereby leading to a high response speed.

The pair of comb-shaped electrodes preferably satisfies that the teeth portions are along each other in a plan view of the main faces of the substrates.

Particularly preferably, the teeth portions of the pair of comb-shaped electrodes are substantially parallel with each other; in other words, each of the comb-shaped electrodes has multiple substantially parallel slits. FIG. 3 is a schematic view of the pair of comb-shaped electrodes in a plan view of the main faces of the substrates.

The pair of comb-shaped electrodes may be formed on the same layer, and may be formed on different layers as long as the effect of the present invention is exerted. Still, the pair of comb-shaped electrodes is formed on the same layer. Here, the phrase “the pair of comb-shaped electrodes is formed on the same layer” means that each of the comb-shaped electrodes is in contact with a common component (e.g. insulating layer, liquid crystal layer) on the liquid crystal layer side and/or the opposite side of the liquid crystal layer side.

The comb-shaped electrodes of the pair are usually capable of generating different electric potentials at a threshold voltage or higher. The “threshold voltage” refers to a voltage generating electric fields that optically change the liquid crystal layer to generate a different display state in the liquid crystal display device. The threshold voltage means that a voltage value that provides a transmittance of 5% with the transmittance in the bright state defined as 100%, for example. The phrase “have different electric potentials at a threshold voltage or higher” herein at least means that a driving operation that generates different electric potentials at a threshold voltage or higher can be implemented. This makes it possible to suitably control the electric field applied to the liquid crystal layer. The upper limit of each of the different electric potentials is preferably 20 V, for example. Examples of a structure for providing different electric potentials include a structure in which one comb-shaped electrode of the pair of comb-shaped electrodes is driven by a certain TFT while the other comb-shaped electrode is driven by another TFT or the other comb-shaped electrode communicates with the electrode disposed below the other comb-shaped electrode. This structure makes it possible to provide different electric potentials. The width of each tooth portion of the pair of comb-shaped electrodes is preferably 2 μm or greater, for example. The gap (also referred to as the space herein) between tooth portions is preferably 2 to 7 μm, for example.

The liquid crystal display panel is preferably arranged such that the liquid crystal molecules in the liquid crystal layer are aligned in the orthogonal direction to the main face of the substrate by an electric field generated between the pair of comb-shaped electrodes or between the first substrate and the second substrate. Preferably, the electrode for the first substrate is a planar electrode. The term “planar electrode” herein includes a mode in which electrode portions in multiple pixels are electrically connected. Preferable examples of such a mode of the planar electrode of the first substrate include a mode in which electrode portions in all of the pixels are electrically connected, and a mode in which electrode portions in a pixel line are electrically connected. Furthermore, the second substrate is preferably provided with a planar electrode. The planar electrode suitably generates a vertical electric field to achieve a high response speed. A particularly preferable mode is such that the electrode of the first substrate is a planar electrode, and the above-described planar electrode is provided to the second substrate. This makes it possible to suitably generate a vertical electric field by a potential difference between the substrates in falling, thereby providing a high response speed. A particularly preferable mode for suitable application of a transverse electric field and a vertical electric field is such that the electrodes (upper electrodes) at the side of the liquid crystal layer of the second substrate constitute a pair of comb-shaped electrodes and the electrode (lower electrode) opposite to the side of the liquid crystal layer of the second substrate is a planar electrode. For example, the planar electrode of the second substrate can be provided below the pair of comb-shaped electrodes of the second substrate (in the layer in the second substrate opposite to the liquid crystal layer), with an insulating layer interposed therebetween. The electrical resistance layer is preferably an insulating layer. The insulating layer may be any layer regarded as an insulating layer in the technical field of the present invention.

The liquid crystal display panel of the present invention usually generates a potential difference at least between the electrode of the first substrate and an electrode (e.g. planar electrode) of the second substrate, in a vertical electric field.

In a transverse electric field, the liquid crystal display panel usually generates a potential difference between the pair of comb-shaped electrodes. For example, the panel may be in a mode such that a higher potential difference is generated between the pair of comb-shaped electrodes of the second substrate than that between the electrode of the first substrate and an electrode (e.g. planar electrode) of the second substrate. The panel may be in a mode such that a lower potential difference is generated between the pair of comb-shaped electrodes of the second substrate than that between the electrode of the first substrate and an electrode of the second substrate.

The planar electrode(s) of the first substrate and/or the second substrate may have any shape regarded as a planar shape in the technical field of the present invention. The planar electrode(s) may have, for example, alignment control structures such as ribs and/or slits in part of the region, or may have alignment control structures in the center portion of a pixel in a plan view of the main faces of the substrates. Still, the planar electrode(s) preferably substantially do/does not have alignment control structures.

The liquid crystal layer preferably contains liquid crystal molecules aligned in the orthogonal direction to the main faces of the substrates when no voltage is applied. Here, “the liquid crystal molecules aligned in the orthogonal direction to the main faces of the substrates” are molecules regarded as being aligned vertically to the main faces of the substrates in the technical field of the present invention, including those substantially aligned in the orthogonal direction. The liquid crystal layer suitably contains liquid crystal molecules aligned in the orthogonal direction to the main faces of the substrates at a voltage lower than the threshold voltage. The phrase “when no voltage is applied” herein at least satisfies the state regarded as substantially no voltage application in the technical field of the present invention. Such a vertical alignment liquid crystal display panel is advantageous to provide characteristics such as a wide viewing angle and a high contrast, and its application range is widened.

The liquid crystal layer usually contains liquid crystal molecules aligned in the horizontal direction to the main faces of the substrates at a threshold voltage or higher by an electric field generated between a pair of comb-shaped electrodes or between the first substrate and the second substrate. The phrase “aligned in the horizontal direction” herein at least satisfies the state regarded as being aligned in the horizontal direction in the technical field of the present invention. This further improves the transmittance. The liquid crystal molecules in the liquid crystal layer preferably substantially consist of liquid crystal molecules aligned in the horizontal direction to the main faces of the substrates at a threshold voltage or higher.

The liquid crystal layer preferably includes liquid crystal molecules having positive anisotropy of dielectric constant (positive liquid crystal molecules). The liquid crystal molecules having positive anisotropy of dielectric constant are aligned in a certain direction when an electric field is applied. The alignment thereof is easily controlled and such molecules provide a higher response speed. The liquid crystal layer may also preferably include liquid crystal molecules having negative anisotropy of dielectric constant (negative liquid crystal molecules). This further improves the transmittance. From the viewpoint of a high response speed, the liquid crystal molecules preferably substantially consist of liquid crystal molecules having positive anisotropy of dielectric constant. From the viewpoint of a transmittance, the liquid crystal molecules preferably substantially consist of liquid crystal molecules having negative anisotropy of dielectric constant.

At least one of the first substrate and the second substrate is usually provided with an alignment film on the liquid crystal layer side. The alignment film is preferably a vertical alignment film. Examples of the alignment film include alignment films formed from an organic material or an inorganic material, and photo-alignment films formed from a photoactive material. The alignment film may be an alignment film without any alignment treatment such as rubbing. Alignment films formed from an organic or inorganic material and photo-alignment films each enable simplification of the process to reduce the cost, as well as improvement in the reliability and the yield. If an alignment film is rubbed, the rubbing may cause disadvantages such as liquid crystal contamination due to impurities from rubbing cloth, dot defects due to contaminants, and uneven display due to uneven rubbing in each liquid crystal panel. The present invention can eliminate these disadvantages. At least one of the first substrate and the second substrate preferably has a polarizing plate on the side opposite to the liquid crystal layer. The polarizing plate is preferably a circularly polarizing plate. The largest advantage of using a circularly polarizing plate is that when external light enters the display panel, unnecessary reflection by components such as TFT wirings can be reduced. A linearly polarizing plate is likely to allow the TFT wirings to reflect the external light at a higher possibility. Even in such a bright state, use of a circularly polarizing plate is suitable as a way of suppressing unnecessary reflection to increase the display characteristics. Use of a circularly polarizing plate also contributes to an increase in the transmittance. The polarizing plate may also preferably be a linearly polarizing plate. This makes it possible to give excellent viewing angle characteristics.

The first substrate and the second substrate of the liquid crystal display panel of the present invention constitute a pair of substrates sandwiching the liquid crystal layer. They each may have an insulation substrate (e.g. glass, resin) as its base material, and the substrates are formed by disposing lines, electrodes, color filters, and the like on the insulation substrate.

Preferably, at least one of the pair of comb-shaped electrodes is a pixel electrode and the second substrate having the pair of comb-shaped electrodes is an active matrix substrate. The liquid crystal display panel of the present invention may be of a transmission type, a reflection type, or a transflective type.

The present invention also relates to a liquid crystal display device including the liquid crystal display panel of the present invention. Preferable modes of the liquid crystal display panel in the liquid crystal display device of the present invention are the same as the aforementioned preferable modes of the liquid crystal display panel of the present invention. Examples of the liquid crystal display device include displays of personal computers, televisions, onboard devices such as automotive navigation systems, and personal digital assistants such as mobile phones. Particularly preferably, the liquid crystal display device is applied to devices used at low-temperature conditions, such as onboard devices including automotive navigation systems.

The configurations of the liquid crystal display panel of the present invention and the preferred modes thereof are applicable to a liquid crystal display panel having an FFS structure. In such a liquid crystal display panel having an FFS structure, a slit electrode is usually provided to the second substrate thereof in place of a pair of comb-shaped electrodes that are capable of being separately driven.

The configurations of the liquid crystal display panel and the liquid crystal display device of the present invention are not especially limited by other components as long as they essentially include such components, and other configurations usually used in liquid crystal display panels and liquid crystal display devices may appropriately be applied.

The aforementioned modes may be employed in appropriate combination as long as the combination is not beyond the spirit of the present invention.

### Advantageous Effects of Invention

The liquid crystal display panel and the liquid crystal display device of the present invention can provide a sufficiently high response speed and an excellent transmittance.

### BRIEF DESCRIPTION OF DRAWINGS

FIG. 1 is a schematic cross-sectional view showing a liquid crystal display panel of Embodiment 1 in the presence of a transverse electric field.

FIG. 2 is a schematic cross-sectional view showing the liquid crystal display panel of Embodiment 1 in the presence of a vertical electric field.

FIG. 3 is a schematic plan view showing a subpixel in the liquid crystal display panel of Embodiment 1.

FIG. 4 is a schematic cross-sectional view showing the liquid crystal display panel of Embodiment 1 in the presence of a transverse electric field.

FIG. 5 shows simulation results relating to the liquid crystal display panel shown in FIG. 4.

FIG. 6 is a graph showing the relation between time (ms) and transmittance (%) of liquid crystal display panels of Embodiment 1 and Embodiment 2.

FIG. 7 is a graph showing the relation between time (ms) and transmittance (%) of a liquid crystal display panel of Embodiment 3, with various dielectric constants of the dielectric layer.

FIG. 8 is a graph showing the relation between time (ms) and transmittance (%) of the liquid crystal display panel of Embodiment 4, with various thicknesses of the dielectric layer.

FIG. 9 is a schematic view of a liquid crystal display panel.

FIG. 10 shows simulation results relating to the liquid crystal display panel with ε_{oc}=3.0.

FIG. 11 shows simulation results relating to the liquid crystal display panel with ε_{oc}=3.9.

FIG. 12 shows simulation results relating to the liquid crystal display panel with ε_{oc}=6.9.

FIG. 13 is a schematic cross-sectional view of a liquid crystal display panel provided with a dielectric layer on the opposed substrate side in rising (transverse electric field).

FIG. 14 is a schematic cross-sectional view of a liquid crystal display panel provided with a dielectric layer disposed on the opposed substrate side in falling (vertical electric field).

FIG. 15 is a graph showing an applied voltage (V) to time (ms) in a liquid crystal display panel provided with a dielectric layer disposed on the opposed substrate side.

FIG. 16 is a schematic cross-sectional view of a liquid crystal display panel that is provided with a dielectric layer on the opposed substrate side and has an increased vertical electric field effective voltage in rising (transverse electric field).

FIG. 17 is a schematic cross-sectional view of a liquid crystal display panel that is provided with a dielectric layer on the opposed substrate side and has an increased vertical electric field effective voltage in falling (vertical electric field).

FIG. 18 is a graph showing an applied voltage (V) relative to time (ms) in a liquid crystal display panel that is provided with a dielectric layer on the opposed substrate side and has an increased vertical electric field effective voltage.

FIG. 19 is a schematic plan view showing a subpixel in a liquid crystal display panel of Comparative Example 1 having an FFS structure.

FIG. 20 is a schematic cross-sectional view of the liquid crystal display panel of Comparative Example 1 having an FFS structure in rising (in the presence of a fringe electric field).

FIG. 21 shows simulation results relating to the liquid crystal display panel shown in FIG. 20.

FIG. 22 is a schematic cross-sectional view of a liquid crystal display panel of Comparative Example 2.

FIG. 23 is a schematic cross-sectional view showing one example of a liquid crystal display device used for the liquid crystal driving method in the present embodiments.

FIG. 24 is a schematic plan view showing an active drive element and its vicinity used in the present embodiments.

FIG. 25 is a schematic cross-sectional view showing the active drive element and its vicinity used in the present embodiments.

### DESCRIPTION OF EMBODIMENTS

The present invention will be described in detail below in view of the following embodiments and drawings. The present invention is not limited to these embodiments. The term “pixel” herein also means a subpixel unless otherwise specified. The planar electrode may have, for example, dot ribs and/or slits as long as it is regarded as a planar electrode in the technical field of the present invention, but preferably substantially does not have alignment control structures. Of the pair of substrates sandwiching the liquid crystal layer, the display side substrate is also referred to as an upper substrate, and the substrate opposite the display side is also referred to as a lower substrate. Of the electrodes disposed on the substrates, the electrode on the display side is also referred to as an upper electrode, and the electrode on the opposite side of the display is also referred to as a lower electrode. Since the circuit board (second substrate) in each of the present embodiments has thin-film transistors (TFTs), the circuit board is also referred to as a TFT substrate or an array substrate. In the present embodiments, a voltage is applied to at least one electrode (pixel electrode) of the pair of comb-shaped electrodes by turning the TFTs to the ON state in both rising (transverse electric field) and falling (vertical electric field).

In each embodiment, the components or parts having the same function are given the same reference number, unless otherwise stated. Also in the drawings, the symbol (i) refers to the electric potential of one of the comb-shaped electrodes at the upper layer of the lower substrate, the symbol (ii) refers to the electric potential of the other of the comb-shaped electrodes at the upper layer of the lower substrate, the symbol (iii) refers to the electric potential of the planar electrode at the lower layer of the lower substrate, and the symbol (iv) refers to the electric potential of the planar electrode of the upper substrate.

### Embodiment 1

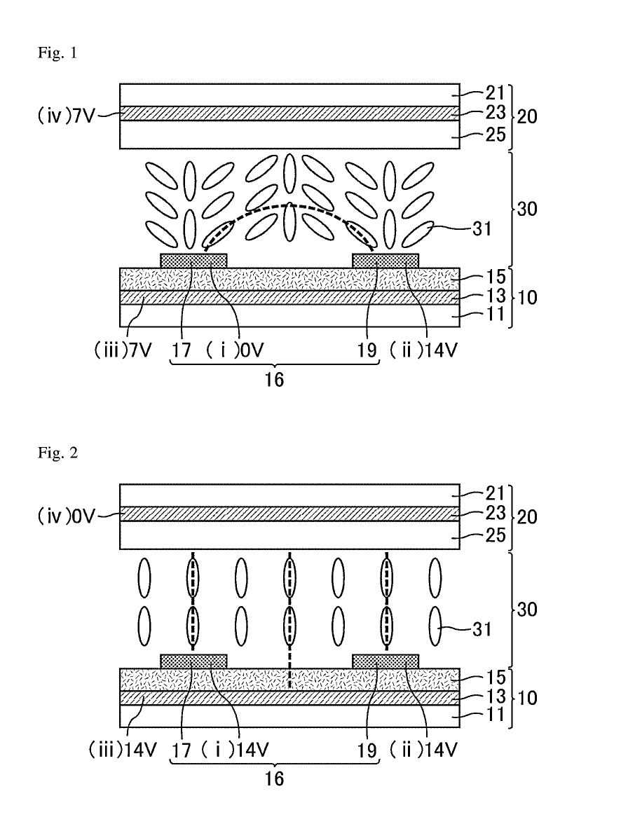

FIG. 1 is a schematic cross-sectional view showing the liquid crystal display panel of Embodiment 1 in the presence of a transverse electric field. FIG. 2 is a schematic cross-sectional view showing the liquid crystal display panel of Embodiment 1 in the presence of a vertical electric field. In each of FIG. 1 and FIG. 2, the dot line indicates the direction of an electric field generated. The liquid crystal display panel of Embodiment 1 has a vertical-alignment three-layered electrode structure (upper electrodes of the lower substrate, which serve as the second layer, are a pair of comb-shaped electrodes 16) using liquid crystal molecules 31 which are a positive liquid crystal. In rising, as shown in FIG. 1, a transverse electric field generated by a potential difference of 14 V between a pair of comb-shaped electrodes 16 (for example, a comb-shaped electrode 17 at an electric potential of 0 V and a comb-shaped electrode 19 at an electric potential of 14 V) rotates the liquid crystal molecules. In this case, substantially no potential difference is generated between the substrates (between a counter electrode 13 at an electric potential of 7 V and a counter electrode 23 at an electric potential of 7 V).

In falling, as shown in FIG. 2, a vertical electric field generated by a potential difference of 14 V (the maximum potential difference is probably around this) between the substrates (for example, between each of the counter electrode 13, the comb-shaped electrode 17, and the comb-shaped electrode 19 at an electric potential of 14 V and the counter electrode 23 at an electric potential of 0 V) rotates the liquid crystal molecules. In this case, substantially no potential difference is generated between the pair of comb-shaped electrodes 16 (for example, consisting of the comb-shaped electrode 17 at an electric potential of 14 V and the comb-shaped electrode 19 at an electric potential of 14 V).

In both the rising and the falling, an electric field rotates the liquid crystal molecules to provide a high response speed. In other words, the transverse electric field between the pair of comb-shaped electrodes 16 leads to the ON state to give a high transmittance in the rising, whereas the vertical electric field between the substrates leads to the ON state to give a high response speed in the falling. Here, the liquid crystal display panel in the present embodiments features turning to the ON state by a vertical electric field between the substrates in falling. The effects achieved in the falling, such as the response speed, are also referred to as the OFF characteristics herein because the display is turned OFF. Furthermore, the transverse electric field by comb driving also provides a high transmittance in apertures.

The liquid crystal display panel of Embodiment 1 further has a dielectric layer 25 (overcoat layer) on the opposed substrate 20 side for a further increase in the transmittance as shown in FIG. 1 and FIG. 2. Preferably, the dielectric layer 25 is formed from, for example, an ultraviolet (UV) curable resin. In this case, the same effect as that of increasing the thickness of the liquid crystal cell, namely the state with a large effect of the transverse electric field between the comb-shaped electrodes, is achieved. In this case, the liquid crystal amount is smaller than that in the case of increasing the thickness of the liquid crystal cell. With an aid of the vertical electric field in falling for the response of liquid crystal molecules, a high response speed is achieved also in falling (on the decay side). In Embodiment 1, the dielectric constant ε_{oc} of the dielectric layer 25 is 3.0, and thickness d_{oc} of the dielectric layer is 3.0 μm.

Embodiment 1 and the following embodiments use a positive liquid crystal as the liquid crystal. Still, a negative liquid crystal may also be used instead of the positive liquid crystal. In the case of a negative liquid crystal, a potential difference between the pair of substrates aligns the liquid crystal molecules in the horizontal direction and a potential difference between the pair of comb-shaped electrodes aligns the liquid crystal molecules in the orthogonal direction. This provides an excellent transmittance, and an electric field rotates the liquid crystal molecules to provide a high response speed in both the rising and the falling. Also, provision of a dielectric layer on the opposed substrate side sufficiently increases the transverse electric field effect. In this case, the transverse electric field achieves the OFF characteristics (an increase in the response speed in falling, a sufficient decrease in the transmittance in black display).

As shown in FIG. 1 and FIG. 2, the liquid crystal display panel of Embodiment 1 includes an array substrate 10, a liquid crystal layer 30, and an opposed substrate 20 (color filter substrate) stacked in the order set forth from the back side to the viewing side of the liquid crystal display panel. As shown in FIG. 2, the liquid crystal display panel of Embodiment 1 vertically aligns the liquid crystal molecules at a voltage lower than the threshold voltage. As shown in FIG. 1, an electric field generated between the upper electrodes 17 and 19 (the pair of comb-shaped electrodes 16) disposed on the glass substrate 11 (second substrate) tilts the liquid crystal molecules in the horizontal direction between the pair of comb-shaped electrodes 16 when a voltage difference between the comb-shaped electrodes is not lower than the threshold voltage, thereby controlling the amount of light transmitted. The planar lower electrode 13 (counter electrode 13) is disposed such that it sandwiches an insulating layer 15 with the upper electrodes 17 and 19 (the pair of comb-shaped electrodes 16). The insulating layer 15 may be formed from an oxide film (e.g. SiO₂), a nitride film (e.g. SiN), or an acrylic resin, for example, and these materials may be used in combination. The common electrodes 13 and 23 have a planar shape. Here, there may be commonly connected counter electrodes 13 corresponding to even-numbered lines and commonly connected counter electrodes 13 corresponding to odd-numbered lines of the gate bus lines. Such an electrode is also referred to as a planar electrode herein. The counter electrode 23 is commonly connected to all the pixels.

Although not shown in FIG. 1 and FIG. 2, a polarizing plate is disposed on each substrate at the side opposite to the liquid crystal layer. The polarizing plate may be a circularly polarizing plate or may be a linearly polarizing plate. An alignment film is disposed on the liquid crystal layer side of each substrate. The alignment films each may be an organic alignment film or may be an inorganic alignment film as long as they align the liquid crystal molecules orthogonally to the film surface.

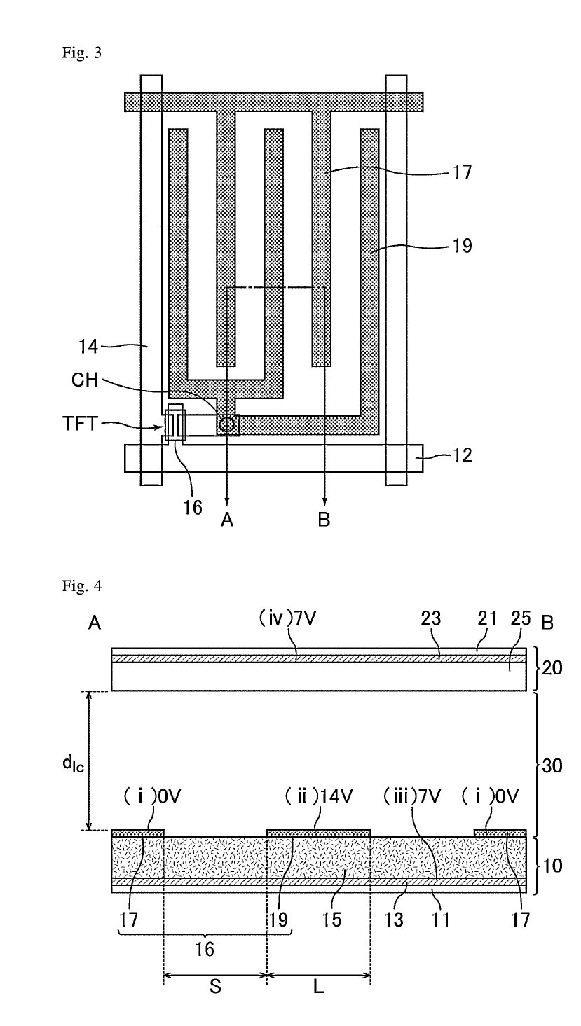

FIG. 3 is a schematic plan view showing a subpixel in the liquid crystal of Embodiment 1. A voltage supplied from an image signal line 14 is applied to the comb-shaped electrode 19, which drives the liquid crystal material, through a semiconductor layer SC of a thin film transistor element (TFT) at the timing when the pixel is selected by a scanning signal line 12. The comb-shaped electrode 17 and the comb-shaped electrode 19 are formed on the same layer in the present embodiment and are preferably in a mode where they are formed on the same layer. Still, the comb-shaped electrodes may be formed on different layers as long as a voltage difference is generated between the comb-shaped electrodes to apply a transverse electric field and provides one effect of the present invention, that is, the effect of improving the transmittance. The comb-shaped electrode 19 is connected to a drain electrode that extends from the TFT through a contact hole CH.

(Verification of Response Performance and Transmittance by Simulation)

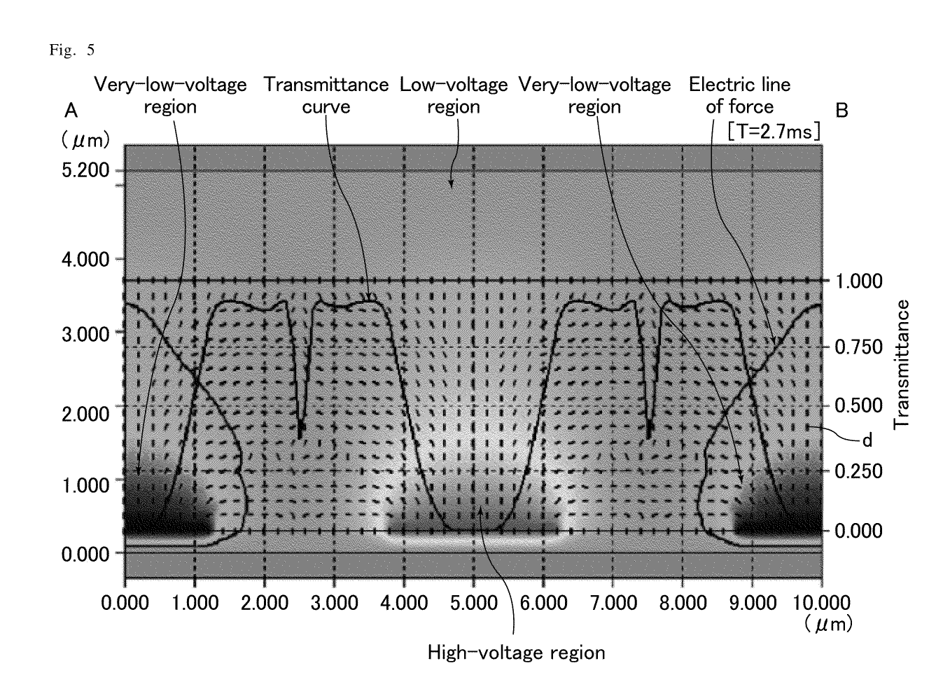

FIG. 4 is a schematic cross-sectional view showing the liquid crystal display panel of Embodiment 1 in the presence of a transverse electric field, taken along the A-B line in FIG. 3. The comb driving of Embodiment 1 generated a transverse electric field between the pair of comb-shaped electrodes 16 (e.g. the comb-shaped electrode 17 at an electric potential of 0 V and the comb-shaped electrode 19 at an electric potential of 14 V), and thereby rotated the liquid crystal molecules in a wide range between the pair of comb-shaped electrodes (FIG. 4, FIG. 5 described later).

FIG. 5 shows simulation results relating to the liquid crystal display panel shown in FIG. 4. FIG. 5 shows the simulation results of director d, electric field, and transmittance distribution after the rising (here, “T=2.7 ms” in FIG. 5 indicates the horizontal axis (time axis) in the graph described later). The graph drawn by a solid line indicates the transmittance. The graph drawn by a dotted line indicates the electric line of force. The director d indicates the alignment direction of the major axis of the liquid crystal molecules. The simulation was performed with a liquid crystal layer thickness (cell thickness) d_{lc} of 3.4 μm and a comb gap S of 2.6 μm.

The width L of each comb-shaped electrode in the present embodiments is preferably 2 μm or greater, for example. The electrode gap S between the comb-shaped electrodes is preferably 2 μm or greater, for example. The preferred upper limit of both of these values is 7 μm, for example. The ratio (L/S) between the electrode gap S and the electrode width L is preferably 0.4 to 3, for example. The lower limit thereof is more preferably 0.5, whereas the upper limit thereof is more preferably 1.5.

The cell thickness d_{lc} of the liquid crystal layer is 3.4 μm. The cell thickness is preferably 2 to 7 μm. With a cell thickness of 7 μm or smaller, excellent viewing angle characteristics are achieved, and a problem from the cost aspect, such as an increase in the amount of liquid crystal molecules, can also be solved. The cell thickness d_{lc} herein is preferably calculated by averaging the thicknesses throughout the liquid crystal layer in the liquid crystal display panel.

With the dielectric layer (overcoat layer) 25 disposed on the opposed substrate side, the liquid crystal display panel of Embodiment 1 achieves a larger effect of the transverse electric field generated by the comb-shaped electrodes in the liquid crystal layer, thereby increasing the utilization efficiency of light (responsibility of liquid crystal molecules).

A liquid crystal display device including the liquid crystal display panel of Embodiment 1 may appropriately include the components provided to a common liquid crystal display device (e.g. light source). The same applies to the embodiments described later.

### Embodiment 2

In Embodiment 2, the driving method in falling applies a greater vertical electric field. Specifically, the voltage difference between the upper and lower electrodes is increased. Thereby, the response speed in falling can be sufficiently increased.

The configurations in Embodiment 2 are the same as the configurations in Embodiment 1 except that the voltage applied was changed as shown in FIG. 16 to FIG. 18 described later, and the potential difference of the voltage applied between the first substrate and the second substrate in falling was changed from 7 V to 14 V.

### Embodiment 3

In Embodiment 3, the dielectric constant ε_{oc} of the dielectric layer was changed to 3.0, 3.9, or 6.9. The other configurations in Embodiment 3 are the same as those in Embodiment 1.

### Embodiment 4

In Embodiment 4, the thickness d_{oc} of the dielectric layer was changed to 1.5 μm, 3.0 μm, or 4.5 μm. The other configurations in Embodiment 4 are the same as those in Embodiment 1.

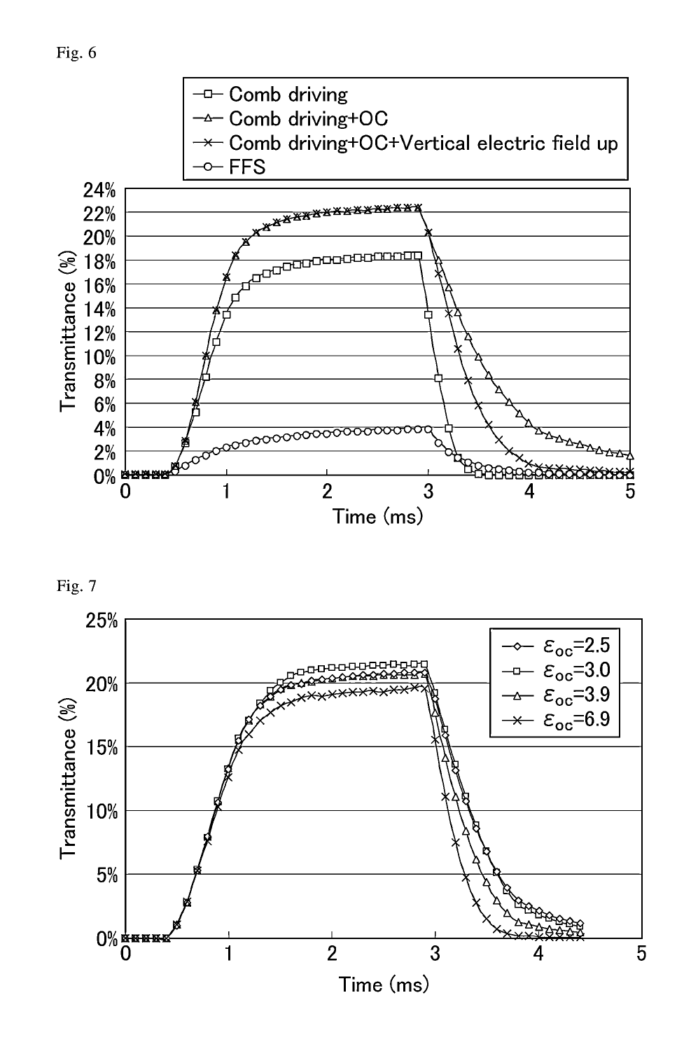

FIG. 6 is a graph showing the relation between time (ms) and transmittance (%) of liquid crystal display panels of Embodiment 1 and Embodiment 2.

In FIG. 6, the term “FFS” refers to a liquid crystal display panel (of Comparative Example 1 described later) which is driven by a conventional fringe electric field method. The term “comb driving” refers to a liquid crystal display panel (of Comparative Example 2 described later) which is the same as the liquid crystal display panel of Embodiment 1, except that the display panel does not include a dielectric layer. The term “comb driving+OC” refers to a liquid crystal display panel of Embodiment 1 which has a dielectric layer (overcoat layer) on the opposed substrate side. The term “comb driving+OC +vertical electric field up” refers to a liquid crystal display panel (of Embodiment 2) which is the same as the liquid crystal display panel of Embodiment 1, except that the voltage difference between the planar electrode of the first substrate and the planar electrode of the second substrate in the presence of a vertical electric field was changed from 7 V to 14 V.

The transmittance in the case of “fringe electric field” (FFS), which is a conventional transverse electric field driving method, is about 4.0%, while the transmittance increases to about 18% by driving by comb electric field. Also with a dielectric layer disposed on the opposed substrate side, the transmittance increases to about 22%, and thereby the effects of the present invention are achieved.

The response speed is described below. The response speed does not change in rising because it depends on the voltages applied to the comb-shaped electrodes. In falling, since a dielectric layer provided decreases the effective voltages which generate the vertical electric field, increasing the voltages applied leads to an increase in the speed in falling (decay speed). The response speed in falling is significantly high in Embodiment 2 in which a greater vertical electric field is generated.

The relation between the dielectric constant and the response speed of the dielectric layer disposed on the opposed substrate side is shown. FIG. 7 is a graph showing the relation between time (ms) and transmittance (%) of a liquid crystal display panel of Embodiment 3, with various dielectric constants ε_{oc} of the dielectric layer. The thickness of the dielectric layer is fixed to d_{oc}=1.5 μm. A dielectric layer with a dielectric constant ε_{oc} of 3.0 was found to achieve the highest transmittance. Suitable examples of the dielectric layer include an easily producible low-dielectric material having a dielectric constant ε_{oc} of, for example, about 2.5, such as a pigment used for, for example, color filters.

The response speed in rising is almost constant (because only the transverse electric field needs to be considered), while the response speed in falling increases as the dielectric constant ε_{oc} increases. This is probably because an effective vertical electric field is likely to be applied to the liquid crystal layer when the dielectric constant ε_{oc} is high. The dielectric constant ε_{oc} of the dielectric layer is preferably 3.9 or greater, and more preferably 6 or greater.

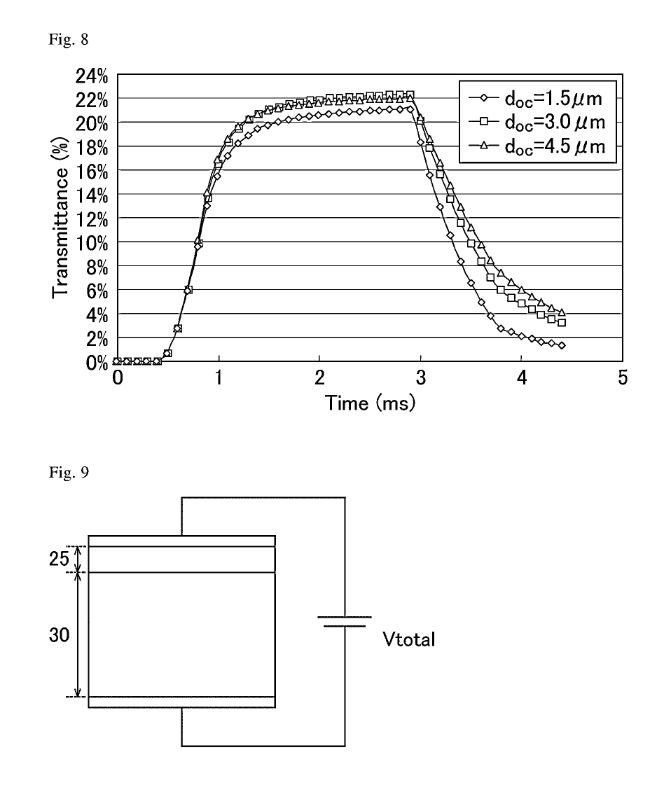

The relation between the thickness d_{oc} and the response speed of the dielectric layer is described. FIG. 8 is a graph showing the relation between time (ms) and transmittance (%) of the liquid crystal display panel of Embodiment 4, with various thicknesses of the dielectric layer.

The transmittance increases as the thickness d_{oc} of the dielectric layer becomes greater, but there probably is a certain threshold value.

The response speed is constant in rising, but the speed in falling (decay speed) decreases as the thickness d_{oc} increases in falling. This is because a vertical electric field is not easily applied. This phenomenon is described in detail below. The thickness d_{oc} of the dielectric layer is preferably 3 μm smaller, more preferably 2 μm or smaller, and still more preferably 1.5 μm or smaller, in terms of increasing the speed in falling. The thickness d_{oc} of the dielectric layer is preferably calculated by averaging the thicknesses throughout the liquid crystal layer.

The relation between the response speed in the presence of a vertical electric field (decay speed) and the overcoat layer conditions is described using the following equations. FIG. 9 is a schematic view of a liquid crystal display panel. In the following equations, the symbol d_{oc} indicates the thickness of the dielectric layer 25. The symbol d_{lc} indicates the thickness of a liquid crystal layer 30. The symbol Coc indicates the capacity of the dielectric layer 25. The symbol Coc indicates the capacity of the liquid crystal layer 30. The symbol ε_{oc} indicates the relative dielectric constant of the dielectric layer 25. The symbol ε_{lc} indicates the relative dielectric constant of the liquid crystal layer 30. The symbol ε₀ indicates a vacuous dielectric constant. The symbol Voc indicates an electric field applied to the dielectric layer. The symbol Vlc indicates the electric field applied to the liquid crystal layer. Also, Vₜₒₜₐₗ=Voc+Vlc.

Coc=ε₀ε_{oc}(S/d_{oc})

Clc=ε₀ε_{lc}(S/d_{lc})

Cₜₒₜₐₗ=1/Coc+1/Clc=(Clc+Coc)/(Coc×Clc)

Voc={Clc/(Clc+Coc)}Vₜₒₜₐₗ

Vlc={Coc/(Clc+Coc)}Vₜₒₜₐₗ

The above equations show that as the thickness d_{oc} of the dielectric layer increases, the voltage applied to the liquid crystal layer decreases, thereby decreasing the response speed in falling (decay speed). Also, as the dielectric constant ε_{oc} of the dielectric layer decreases, the voltage applied to the liquid crystal layer decreases, thereby decreasing the speed in falling.

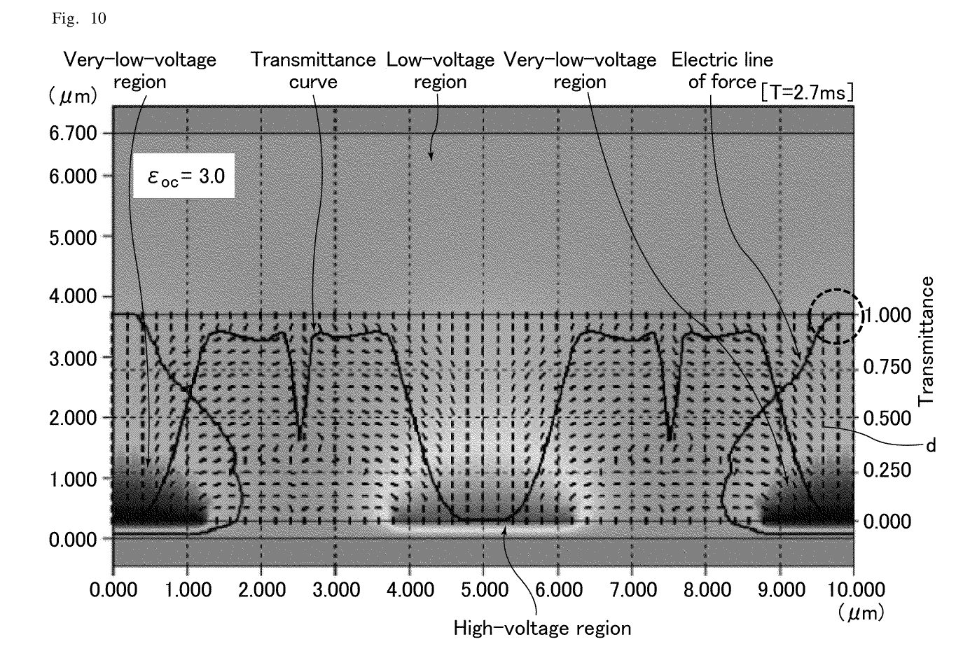

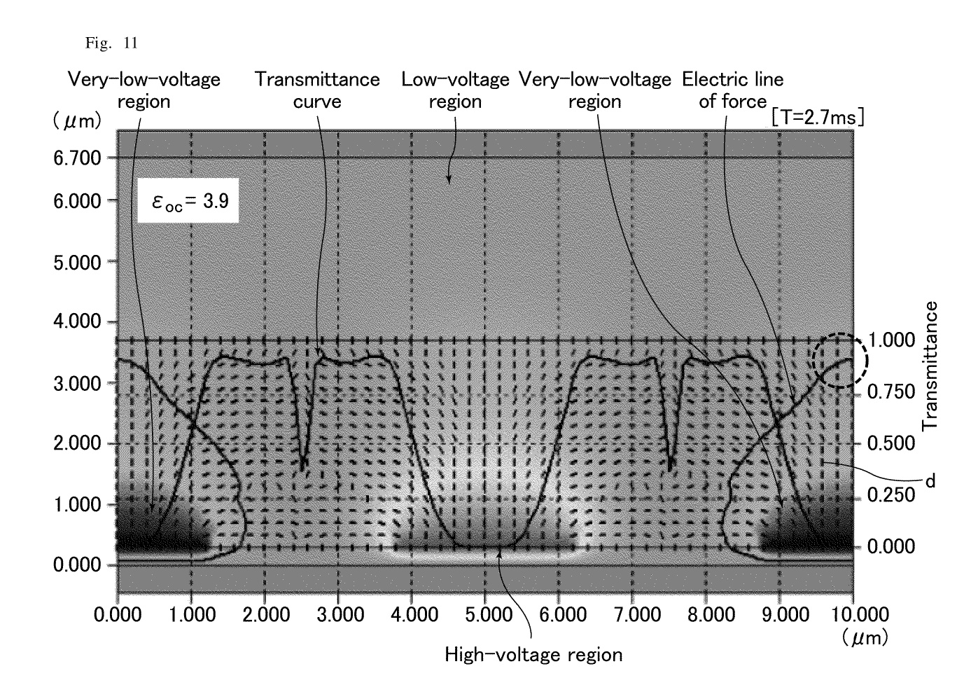

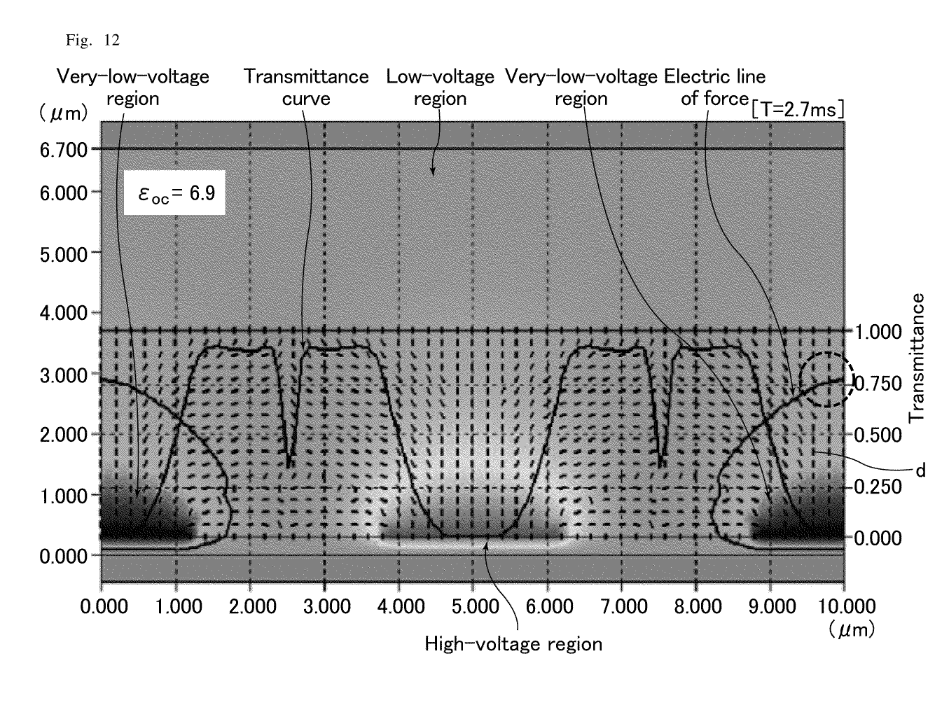

The response states after a transverse electric field was applied to the liquid crystal display panel with different dielectric constants ε_{oc} of the dielectric layers in Embodiment 3 are compared. FIG. 10 shows simulation results relating to the liquid crystal display panel with ε_{oc}=3.0. FIG. 11 shows simulation results relating to the liquid crystal display panel with ε_{oc}=3.9. FIG. 12 shows simulation results relating to the liquid crystal display panel with ε_{oc}=6.9.

In FIG. 10 to FIG. 12, the transmittance curves are almost the same, but comparison of the electric lines of force on the electrode side shows that the electric line of force is spread to a wider range in the liquid crystal layer with a lower dielectric constant ε_{oc}. This suggests that liquid crystal molecules in a wide range respond when the electric line of force is distributed in a wide range, whereby the transmittance is increased. The phenomenon that the effect of the vertical electric field is more significant with a higher dielectric constant ε_{oc} is explained from the relation between the dielectric constant ε_{oc}of the dielectric layer disposed on the opposed substrate side and the response speed, and from the relation between the response speed in the presence of a vertical electric field and the overcoat layer conditions. The phenomenon may have an influence on the state in the presence of a transverse electric field.

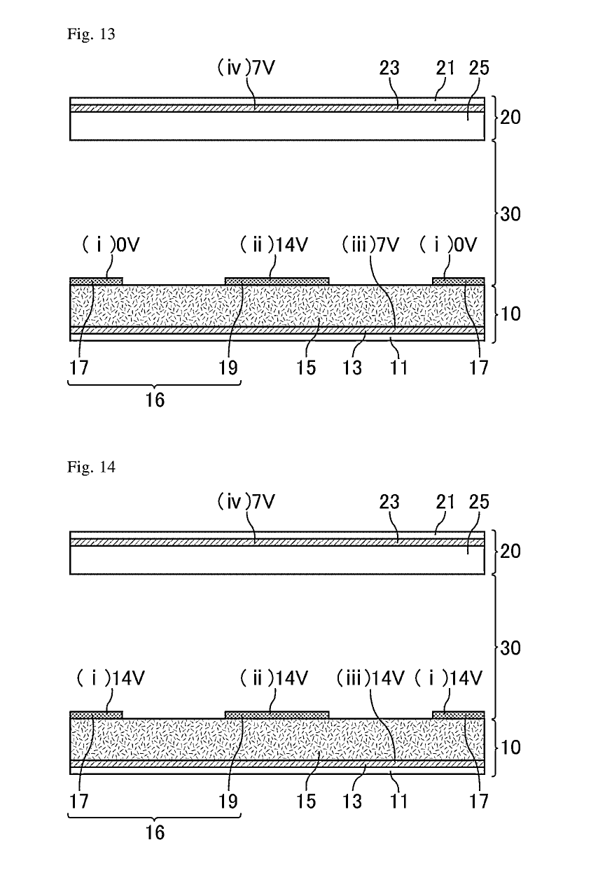

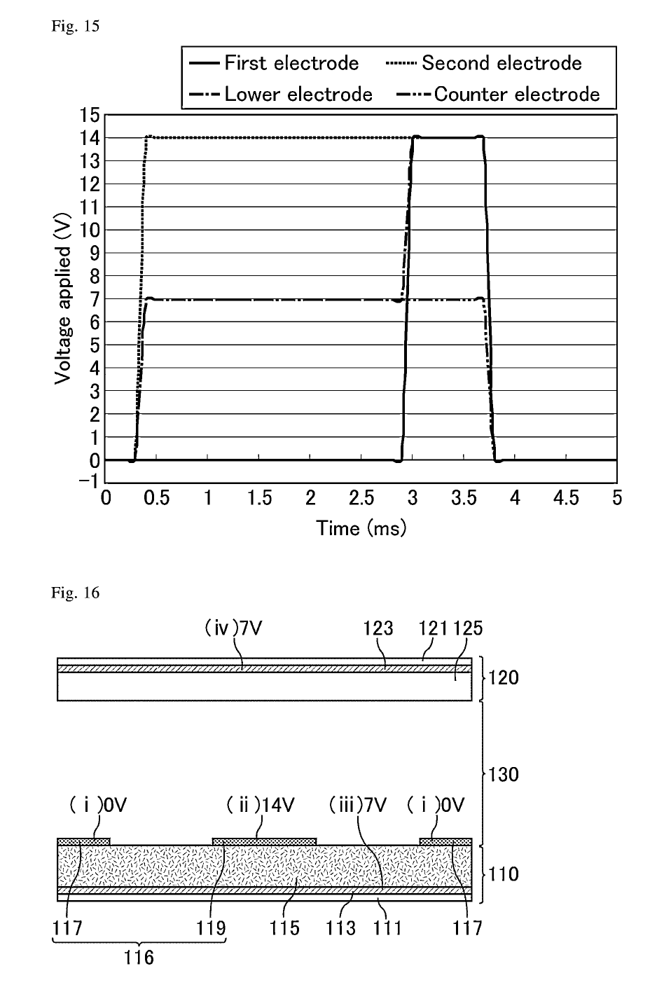

FIG. 13 to FIG. 15 each show a liquid crystal display panel (liquid crystal display panel with a dielectric layer disposed on the opposed substrate side) of Embodiment 1. FIG. 13 is a schematic cross-sectional view of a liquid crystal display panel with a dielectric layer disposed on the opposed substrate side in rising (in the presence of a transverse electric field). FIG. 14 is a schematic cross-sectional view of a liquid crystal display panel with a dielectric layer disposed on the opposed substrate side in falling (in the presence of a vertical electric field). FIG. 15 is a graph showing an applied voltage (V) relative to time (ms) in a liquid crystal display panel provided with a dielectric layer disposed on the opposed substrate side.

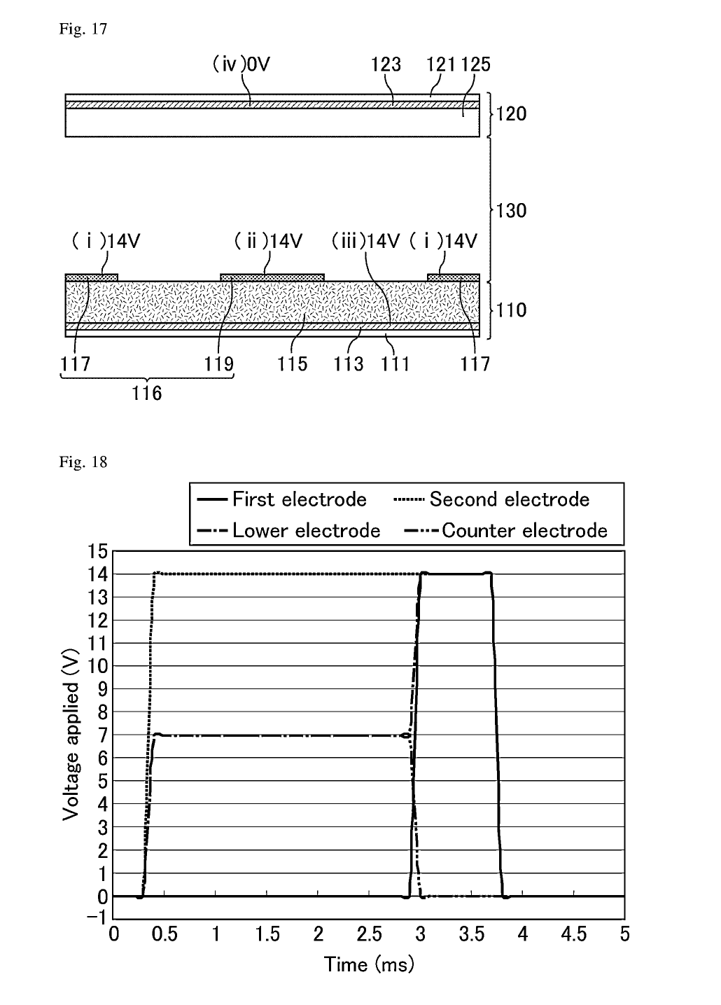

FIG. 16 to FIG. 18 each show a liquid crystal display panel (liquid crystal display panel with an increased vertical electric field effective voltage) of Embodiment 2. FIG. 16 is a schematic cross-sectional view of a liquid crystal display panel with a dielectric layer disposed on the opposed substrate side and with the vertical electric field effective voltage increased in rising (in the presence of a transverse electric field). FIG. 17 is a schematic cross-sectional view of a liquid crystal display panel with a dielectric layer disposed on the opposed substrate side and with the vertical electric field effective voltage increased in falling (in the presence of a vertical electric field). FIG. 18 is a graph showing the applied voltage (V) relative to time (ms) in a liquid crystal display panel with a dielectric layer disposed on the opposed substrate side and with the vertical electric field effective voltage increased.

The simulations in FIG. 15 and FIG. 18 were performed with a thickness d_{lc} of the liquid crystal cell of 3.4 μm and an electrode gap =2.6 μm.

The liquid crystal display panels of the present embodiments are easy to produce and capable of achieving a high transmittance. The display panels are also capable of exhibiting a response speed enough to implement the field sequential system.

The liquid crystal display panels of the present embodiments usually require three TFTs per subpixel, and provide a sufficiently increased transmittance with the concept of the present invention applied thereto. The concept of the present invention is applicable regardless of the number of TFTs per subpixel, suitably increasing the transmittance. Liquid crystal display panels with two TFTs per subpixel are possible with, for example, a mode in which the planar electrodes of the second substrate are electrically connected in each pixel line, a mode in which electrodes each of which corresponds to one of the pair of comb-shaped electrodes of the second substrate are electrically connected in each pixel line, or a mode in which one of the pair of comb-shaped electrodes and the planar electrode of the second substrate are electrically connected. Also, liquid crystal display panels with one TFT per subpixel is possible with, for example, a mode in which the planar electrodes of the second substrate are electrically connected in each pixel line and electrodes each of which corresponds to one of the pair of comb-shaped electrodes and the planar electrode of the second substrate are electrically connected.

### Comparative Example 1

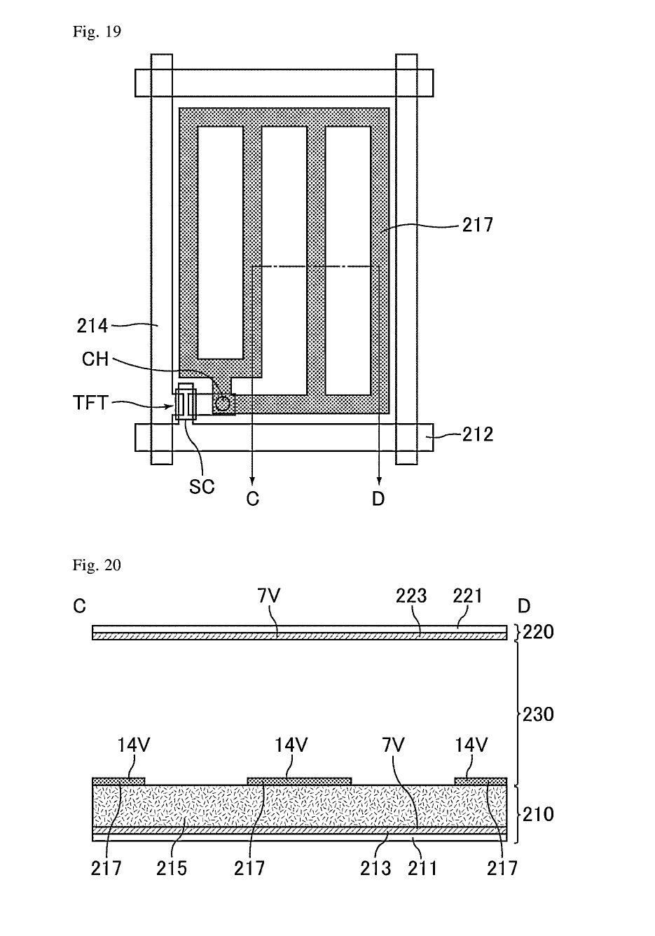

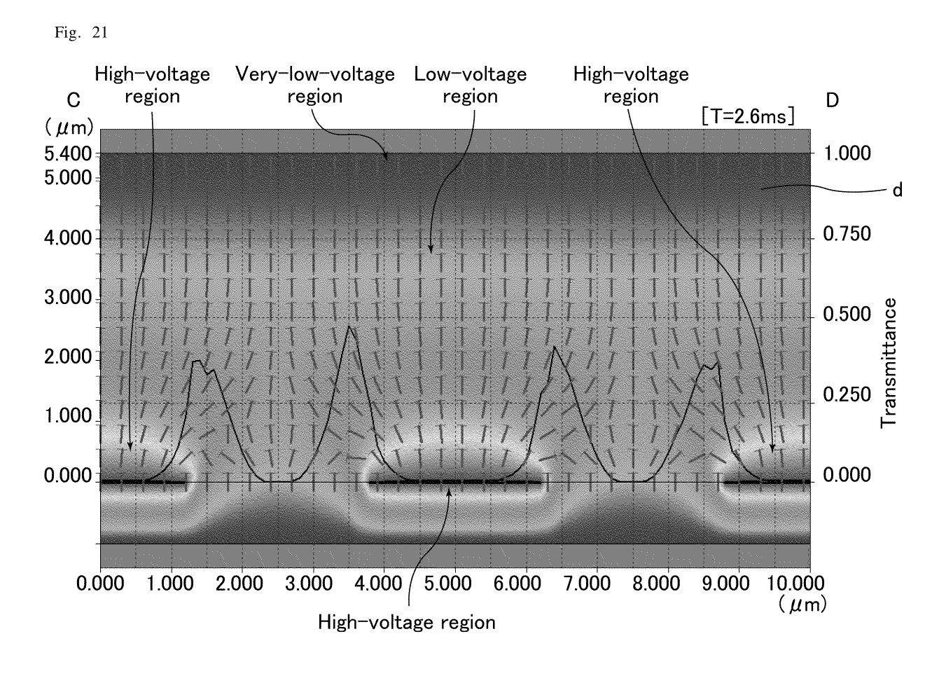

The liquid crystal display panel of Comparative Example 1 implements a conventional fringe drive system which has the same configuration as the configuration of the liquid crystal display panel of Embodiment 1, except that a slit electrode is used for the upper electrode of the lower substrate in place of the pair of comb-shaped electrodes. FIG. 19 is a schematic plan view showing a subpixel in a liquid crystal display panel of Comparative Example 1 having an FFS structure. FIG. 20 is a schematic cross-sectional view of a liquid crystal display panel of Comparative Example 1 having an FFS structure in rising (in the presence of a fringe electric field), taken along the C-D line in FIG. 19. FIG. 21 shows the simulation results relating to the liquid crystal display panel shown in FIG. 20. The liquid crystal display panel of Comparative Example 1 generates a fringe electric field by FFS driving as taught in Patent Literature 1. FIG. 21 shows the simulation results of the director d, electric field, and transmittance distribution (cell thickness: 3.4 μm, slit gap: 2.6 μm). The reference numbers in FIG. 20 for Comparative Example 1 are the same as those shown in the drawings for Embodiment 1, except that a numeral “2” was added as the hundred's digit.

### Comparative Example 2

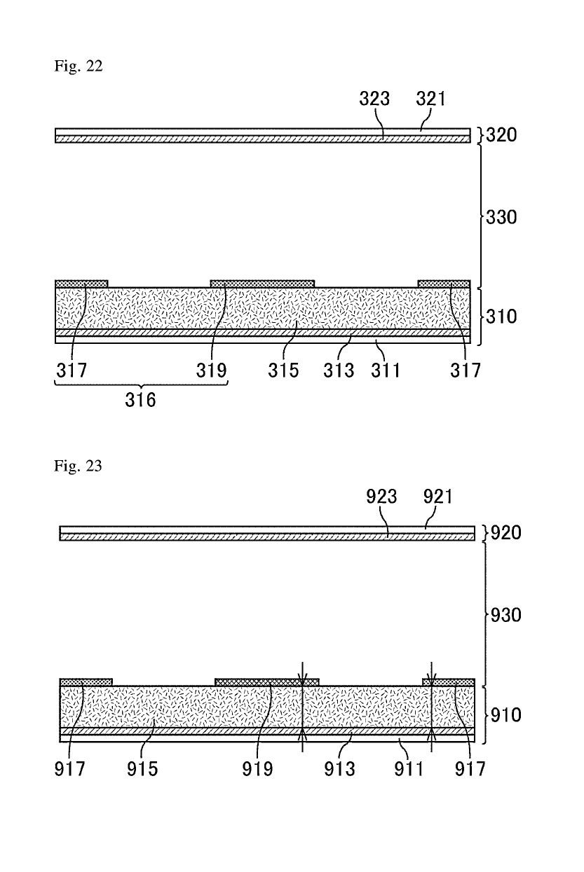

The liquid crystal display panel of Comparative Example 2 has the same configuration as the liquid crystal display panel of Embodiment 1, except that the display panel does not include a dielectric layer. FIG. 22 is a schematic cross-sectional view of the liquid crystal display panel of Comparative Example 2. The reference numbers in FIG. 22 for Comparative Example 1 are the same as those shown in the drawings for Embodiment 1, except that a numeral “3” was added as the hundred's digit.

The configurations such as electrode structures of the liquid crystal display panel and liquid crystal display device of the present invention can be observed by microscopic observation of the TFT substrate and the opposed substrate using a device such as scanning electron microscope (SEM). Also, the driving voltage can be determined by a common method.

### Other Preferable Embodiments

In the embodiments of the present invention, an oxide semiconductor TFT (e.g. IGZO) is preferably used. The following will describe this oxide semiconductor TFT in detail.

At least one of the first substrate and the second substrate usually includes a thin film transistor element. The thin film transistor element preferably includes an oxide semiconductor. In other words, an active layer of an active drive element (TFT) in the thin film transistor element is preferably formed using an oxide semiconductor film such as zinc oxide instead of a silicon semiconductor film. Such a TFT is referred to as an “oxide semiconductor TFT”. The oxide semiconductor characteristically shows a higher carrier mobility and less unevenness in its properties than amorphous silicon. Thus, the oxide semiconductor TFT moves faster than an amorphous silicon TFT, has a high driving frequency, and is suitably used for driving of higher-definition next-generation display devices. In addition, the oxide semiconductor film is formed by an easier process than a polycrystalline silicon film. Thus, it is advantageously applied to devices requiring a large area.

The following characteristics markedly appear in the case of applying the liquid crystal driving method of the present embodiments especially to FSDs (field sequential display devices).

(1) The pixel capacitance is higher than that in a usual VA (vertical alignment) mode (FIG. 23 is a schematic cross-sectional view showing one example of a liquid crystal display device used in the liquid crystal driving method of the present embodiments; in FIG. 23, a large capacitance is generated between the upper electrode and the lower electrode at the portion indicated by an arrow and the pixel capacitance is higher than in the liquid crystal display device of usual vertical alignment (VA) mode). (2) One pixel of a FSD type is equivalent to three pixels (RGB), and thus the capacitance of one pixel is trebled. (3) The gate ON time is very short because 240 Hz or higher driving is required.

Advantages of applying the oxide semiconductor TFT (e.g. IGZO) are as follows.

Based on the characteristics (1) and (2), a 52-inch device has a pixel capacitance of about 20 times as high as a 52-inch UV2A 240-Hz drive device.

Thus, a transistor produced using conventional a-Si is as great as about 20 times or more, disadvantageously resulting in an insufficient aperture ratio.

The mobility of IGZO is about 10 times that of a-Si, and thus the size of the transistor is about 1/10.

Although the liquid crystal display device using color filters (RGB) has three transistors, the FSD type device has only one transistor. Thus, the device can be produced in a size as small as or smaller than that with a-Si.

As the size of the transistor becomes smaller, the Cgd capacitance also becomes smaller. This reduces the load on the source bus lines.

### Specific Examples

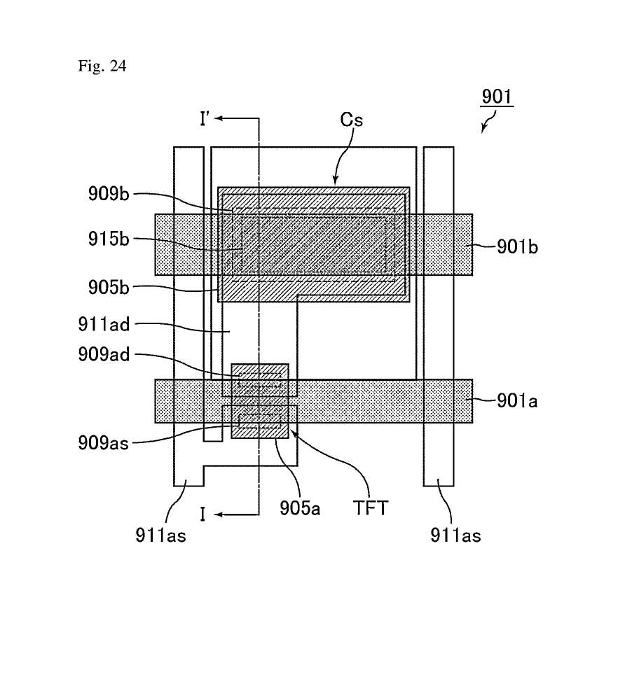

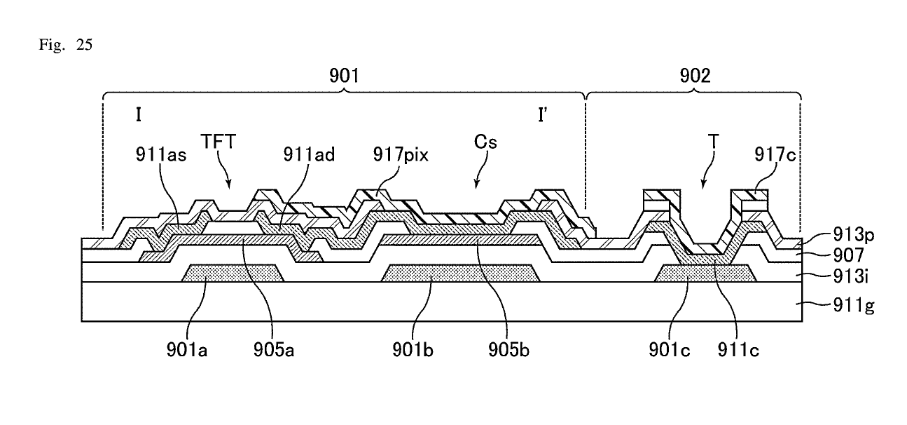

FIG. 24 and FIG. 25 each show a structure (example) of the oxide semiconductor TFT. FIG. 24 is a schematic plan view showing the active drive element and its vicinity used in the present embodiment. FIG. 25 is a schematic cross-sectional view showing an active drive element and its vicinity used in the present embodiment. The symbol T indicates a gate and source terminal. The symbol Cs indicates an auxiliary capacitance.

The following will describe one example (the portion in question) of a production process of the oxide semiconductor TFT.

Active layer oxide semiconductor layers 905a and 905b of an active drive element (TFT) using the oxide semiconductor film are formed as follows.

At first, an In—Ga—Zn—O semiconductor (IGZO) film with a thickness of 30 nm or greater but 300 nm or smaller is formed on an insulating layer 913i by sputtering. Then, a resist mask is formed by photolithography so as to cover predetermined regions of the IGZO film. Next, portions of the IGZO film other than the regions covered by the resist mask are removed by wet etching. Thereafter, the resist mask is peeled off. This provides island-shaped oxide semiconductor layers 905a and 905b. The oxide semiconductor layers 905a and 905b may be formed using other oxide semiconductor films instead of the IGZO film.

Next, an insulating layer 907 is deposited on the whole surface of a substrate 911g and the insulating layer 907 is patterned.

Specifically, at first, an SiO₂ film (thickness: about 150 nm, for example) as an insulating layer 907 is formed on the insulating layer 913i and the oxide semiconductor layers 905a and 905b by CVD.

The insulating layer 907 preferably includes an oxide film such as SiOy.

Use of the oxide film can recover oxygen deficiency on the oxide semiconductor layers 905a and 905b by the oxygen in the oxide film, and thus it more effectively suppresses oxygen deficiency on the oxide semiconductor layers 905a and 905b. Here, a single layer of an SiO₂ film is used as the insulating layer 907. Still, the insulating layer 907 may have a stacked structure of an SiO₂ film as a lower layer and an SiNx film as an upper layer.

The thickness (in the case of a stacked structure, the sum of the thicknesses of the layers) of the insulating layer 907 is preferably 50 nm or greater but 200 nm or smaller. The insulating layer with a thickness of 50 nm or greater more securely protects the surfaces of the oxide semiconductor layers 905a and 905b in the step of patterning the source and drain electrodes. If the thickness of the insulating layer exceeds 200 nm, the source electrodes and the drain electrodes may have a higher step, so that breaking of lines may occur.

The oxide semiconductor layers 905a and 905b in the present embodiment are preferably formed from a Zn—O semiconductor (ZnO), an In—Ga—Zn—O semiconductor (IGZO), an In—Zn—O semiconductor (IZO), or a Zn—Ti—O semiconductor (ZTO). Particularly preferred is an In—Ga—Zn—O semiconductor (IGZO).

The present mode provides certain effects in combination with the above oxide semiconductor TFT. Still, the present mode can be driven using a known TFT element such as an amorphous Si TFT or a polycrystalline Si TFT.

The aforementioned modes of the embodiments may be employed in appropriate combination as long as the combination is not beyond the spirit of the present invention.

The present application claims priority to Patent Application No. 2011-142348 filed in Japan on Jun. 27, 2011 under the Paris Convention and provisions of national law in a designated State, the entire contents of which are hereby incorporated by reference.

### REFERENCE SIGNS LIST

10, 110, 210, 310: Array substrate

11, 21, 111, 121, 211, 221, 311, 321: Glass substrate

12: Scanning signal line

13, 23, 113, 123, 213, 223, 313, 323: Counter electrode

14: Video signal line

25, 125: Dielectric layer

15, 115, 215, 315: Insulating layer

16, 116, 316: Pair of comb-shaped electrodes

17, 19, 117, 119, 317, 319: Comb-shaped electrode

20 120, 220, 320: Opposed substrate

30, 130, 230, 330: Liquid crystal layer

31: Liquid crystal molecule

217: Slit electrode

1. A liquid crystal display panel comprising:
a first substrate;
a second substrate; and
a liquid crystal layer disposed between the substrates,
the first substrate and the second substrate each comprising an electrode,
the first substrate further comprising a dielectric layer,
the electrode of the second substrate including a pair of comb-shaped electrodes and a planar electrode.

2. The liquid crystal display panel according to claim 1,
wherein the liquid crystal display panel has a potential difference of 15 V or less between the electrodes of the first substrate and the second substrate when voltages are applied to the electrodes.

3. The liquid crystal display panel according to claim 1,
wherein the dielectric layer has a dielectric constant of 2.5 or more.

4. The liquid crystal display panel according to claim 1,
wherein the dielectric layer has a thickness of 3.5 μm or less.

5. The liquid crystal display panel according to claim 1,
wherein the electrode of the first substrate is a planar electrode.

6. The liquid crystal display panel according to claim 1,
which is configured to align liquid crystal molecules between the pair of comb-shaped electrodes in the liquid crystal layer in a horizontal direction to the main faces of the substrates by an electric field generated between the pair of comb-shaped electrodes or between the electrode of the first substrate and the electrodes of the second substrate.

7. The liquid crystal display panel according to claim 1,
wherein the liquid crystal layer contains liquid crystal molecules which are aligned in an orthogonal direction to the main faces of the substrates under a voltage lower than a threshold voltage.

8. The liquid crystal display panel according to claim 1,
wherein the liquid crystal layer contains liquid crystal molecules with a positive anisotropy of dielectric constant.

9. The liquid crystal display panel according to claim 1,
wherein at least one of the first substrate and the second substrate comprises a thin film transistor element, and the thin film transistor element comprises an oxide semiconductor.

10. A liquid crystal display device, comprising
the liquid crystal display panel according to claim 1.
